(19) United States
(12) Patent Application Publication
(10) Pub. No.: US 2006/0190560 A1
(43) Pub. Date: Aug. 24, 2006

(54) Remote maintenance/management system for SIP device

(75) Inventor: Yuichi Komine, Kanagawa (JP)

Correspondence Address: YOUNG & THOMPSON, 745 SOUTH 23RD STREET, 2ND FLOOR, ARLINGTON, VA, 22202, US

(73) Assignee: NEC INFRONTIA CORPORATION, KANAGAWA (JP)

(21) Appl. No.: 11/358,114

(22) Filed: Feb. 22, 2006

(30) Foreign Application Priority Data
Feb. 24, 2005 (JP) 2005-048961

(51) Int. Cl. G06F 15/16

(52) U.S. Cl. 709/217

(57) ABSTRACT

There is disclosed a technique for increasing security in a system using the same communication protocol for maintenance/management as used in device functions. An information communication device transmits and receives maintenance/management information for maintenance/management in accordance with the same communication protocol as device function information used for device functions. A maintenance/management device transmits and receives maintenance/management information to/from the information communication device in accordance with the communication protocol. The maintenance/management device transmits and receives maintenance/management information to/from the information communication device in accordance with the communication protocol, and instructs the information communication device on maintenance/management control. The information communication device executes maintenance/management control in accordance with the maintenance/management information.

### BACKGROUND OF THE INVENTION

1. Field of the Invention

The present invention relates to a technique for transmitting and receiving maintenance/management information for SIP devices.

2. Description of the Related Art

Recently, attention is paid to SIP (Session Initiation protocol) used in IP (Internet Protocol) telephones or home information appliances. Besides primary functions (hereafter, called device functions) in SIP devices, maintenance/management functions are important. Device functions in SIP devices, for example, are communications by IP telephones and are used to control home information appliances. In these device functions, SIP is used to establish and disconnect sessions in IP telephones and home information appliances.

Conventionally, for maintenance/management for SIP devices, there is a configuration in which maintenance/management can be performed from the outside via a network. In this configuration, it is necessary to transmit and receive maintenance/management information between the SIP device and a maintenance/management device.

Japanese Patent Laid-Open No. 2001-229110 describes an example of a conventional method of transmitting and receiving maintenance/management information.

FIG. 1 is a block diagram showing the configuration of a conventional system performing maintenance/management for devices via a network. Referring to FIG. 1, LAN (Local Area Network) 87 connected with terminals 83, 84 and PCs (Personal Computers) 85, 86 is connected to internet 81 via gateway 82. Also, LAN 93 connected with terminals 89, 90 and PCs 91, 92 is connected to internet 81 via gateway 88. Further, internet 81 is connected to maintenance center 80.

In FIG. 1, terminals 83, 84, 89, 90 are target devices of maintenance/management.

Maintenance center 80 performs remote maintenance/management for respective terminals 83, 84, 89, 90, namely, target subjects of maintenance/management. Each of terminals 83, 84, 89, 90 accepts a request from maintenance center 80, determines whether access is available or not, and executes control in accordance with the request.

The operation of this system is explained.

First, maintenance center 80 transmits a device information output request or a device information update request to terminals 83, 84, 89, 90 via a WWW (World Wide Web) browser. The device information output request is a request for outputting information stored in devices. The device information update request is a request for updating information set in devices. Terminals 83, 84, 89, 90 output or change device information in accordance with requests from maintenance center 80. With this arrangement, it is possible to perform maintenance/management for respective terminals 83, 84, 89, 90 from remote locations.

However, the above-mentioned conventional technique has the following problems.

It is necessary for devices connected with networks to take into account security, and security devices, such as firewall, are frequently used.

Further, conventional maintenance/management systems use the WWW browser, and thus HTTP (Hyper Text Transfer Protocol) and FTP (File Transfer Protocol) are used for communications. For this reason, in order to make remote maintenance/management possible, it is necessary to set the firewall so that HTTP and FTP are allowed.

FIG. 2 is a block diagram showing a configuration in which the conventional system is applied to maintenance/management for SIP devices. Referring to FIG. 2, SIP device 96 is connected to internet 81 via firewall 94. Also, maintenance/management device 80 and SIP device 95 are connected to internet 81.

Since communications about device functions between SIP devices 95, 96 are performed by SIP, firewall 94 is set so as to allow SIP. Also, since communications about maintenance/management from maintenance/management device 80 to SIP device 96 are performed by HTTP or FTP, firewall 94 has to be set to allow HTTP or FTP.

Accordingly, in the conventional system, it is necessary not only to allow SIP, needed for device functions, but also protocols which are basically not needed, such as HTTP and FTP. Therefore, there is a problem, namely, a deterioration in the security.

Further, in conventional systems, in order to make maintenance/management from remote locations possible, it is necessary to change settings on the security device so that HTTP and FTP are allowed, and operations therefore become complicated.

Furthermore, in conventional systems, in order to make maintenance/management from remote locations possible, it is necessary to implement FTP, HTTP or the like, in addition to SIP, which is fundamentally necessary, and this causes an increase in costs.

### SUMMARY OF THE INVENTION

The object of the present invention is to provide a maintenance/management system for SIP devices, capable of performing maintenance/management from remote locations easily at a low cost while retaining a high level of security.

To achieve the above-mentioned object, a remote maintenance/management system according to the present invention is a remote maintenance/management system for remotely maintaining and managing devices that are implemented with communication protocols that are used to execute device functions, and is provided with an information communication device and a maintenance/management device.

The information communication device transmits and receives maintenance/management information for maintenance/management by the same communication protocol as device function information for device functions, and executes maintenance/management control based on the maintenance/management information.

The maintenance/management device transmits and receives maintenance/management information to/from the information communication device in accordance with the communication protocol, and instructs the information communication device on maintenance/management control.

According to the present invention, it is unnecessary to implement protocols except for communication protocols that are fundamentally necessary for information communication devices. Also, when protocols are restricted for he sake of security, it is unnecessary to allow any protocol except for communication protocols which are fundamentally necessary, and setting operations thereof are not required. As a consequence, maintenance/management can be performed from remote locations easily at low cost while retaining a high level of security.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a conventional system for performing maintenance/management for devices via a network;

FIG. 2 is a block diagram of a configuration in which the conventional system is applied to maintenance/management for SIP devices;

FIG. 3 is a block diagram of a maintenance/management system according to an embodiment;

FIG. 4 is a block diagram of a maintenance/management device according to the embodiment;

FIG. 5 is a block diagram of a SIP device according to the embodiment;

FIG. 6 is a table of an example of maintenance/management control commands;

FIG. 7 is a table of an example of setting information for the SIP device; and

FIG. 8 is a view for example of the operation of the maintenance/management system.

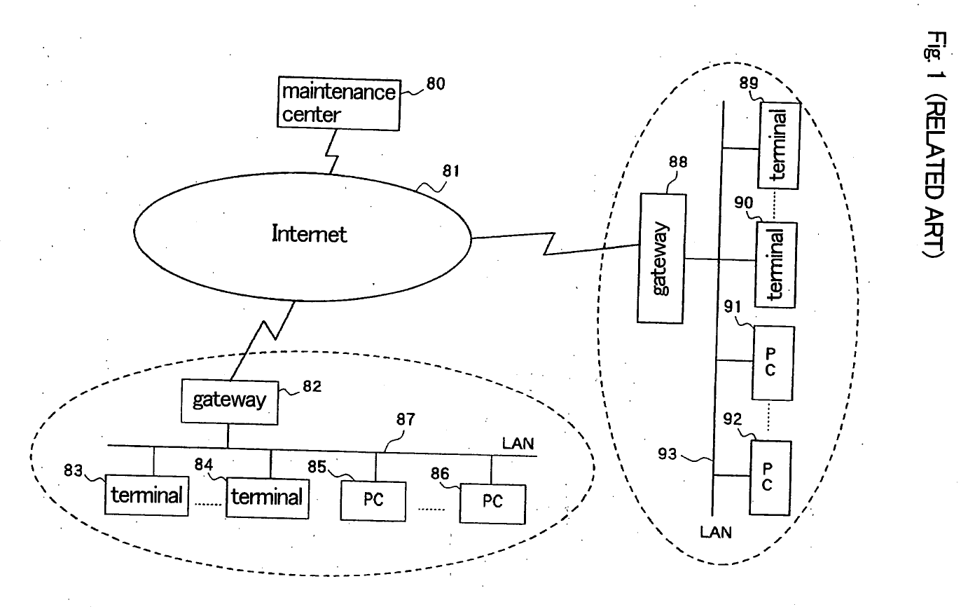

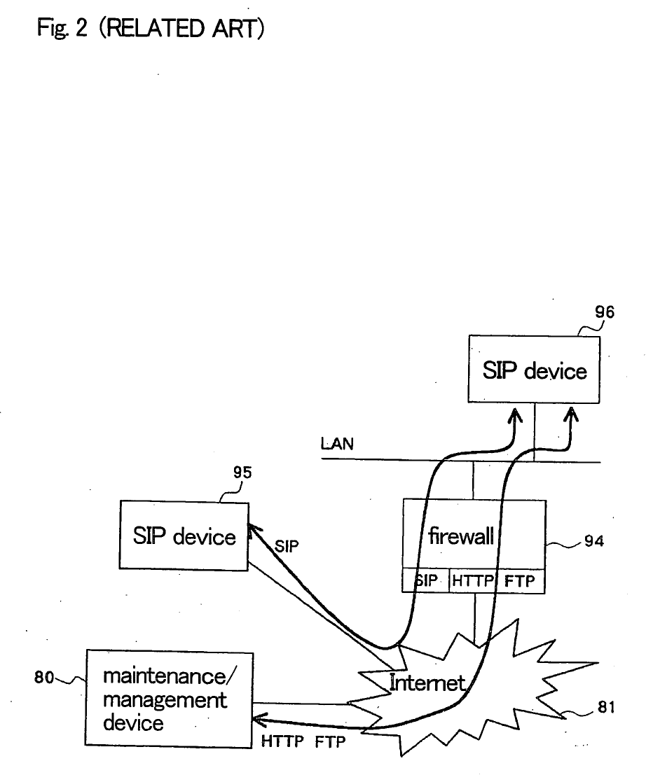

### DESCRIPTION OF THE PREFERRED EMBODIMENTS

In this description, explanation is given of a system for performing maintenance/management for SIP devices via Internet from a maintenance/management device. In this embodiment, SIP devices include a device connected to the internet via a firewall and a device connected to the internet without a firewall.

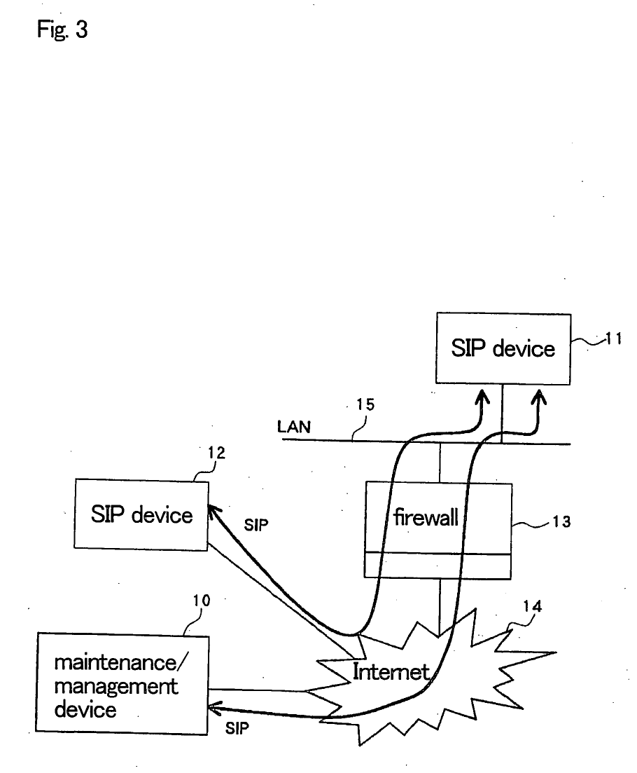

FIG. 3 is a block diagram of a maintenance/management system according to this embodiment. Referring to FIG. 3, this system includes maintenance/management device 10 and SIP devices 11, 12. SIP device 11 is connected to internet 14 via firewall 13. Also, maintenance/management device 10 and SIP device 12 are connected to internet 14.

Maintenance/management device 10 performs maintenance/management for SIP devices 11, 12 from remote locations via internet 14.

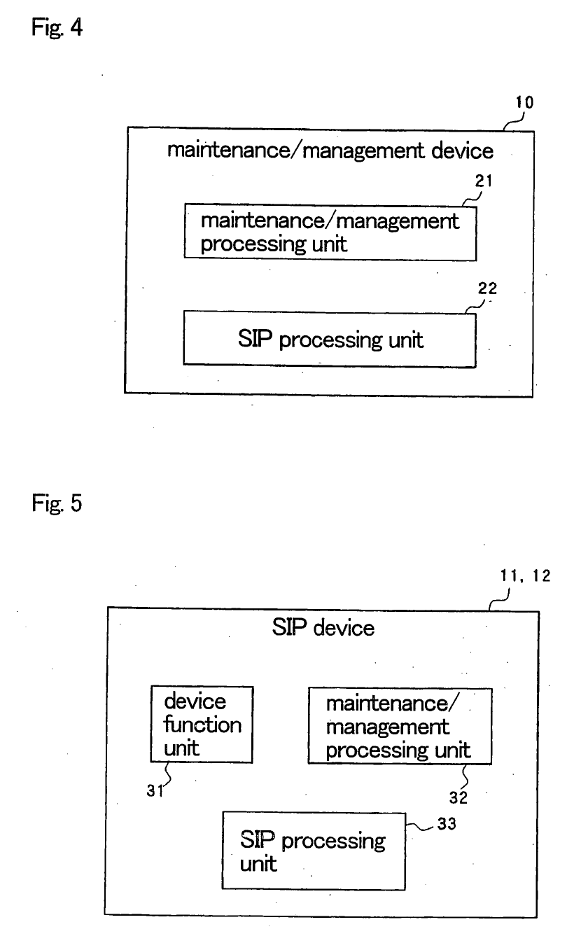

FIG. 4 is a block diagram of a maintenance/management device according to this embodiment. Referring to FIG. 4, maintenance/management device 10 includes maintenance/management processing unit 21 and SIP processing unit 22.

Maintenance/management processing unit 21 performs maintenance/management for SIP devices 11, 12. For that purpose, maintenance/management processing unit 21 produces maintenance/management information and transmits the information to SIP processing unit 22. Maintenance/management processing unit 21 also receives maintenance/management information from SIP devices 11, 12 via SIP processing unit 22 and analyzes the information.

Maintenance/management control is performed, for example, in accordance with an input command by an operator. Examples of maintenance/management control, include control for acquiring log information or current setting information from SIP devices, control for defining setting information to SIP devices, and control for resetting SIP devices. Results of maintenance/management control may be displayed to the operator who inputs the command.

SIP processing unit 22 performs a SIP process for the maintenance/management information processed by maintenance/management processing unit 21, and transmits and receives SIP packets of the maintenance/management information to/from SIP devices 11, 12.

SIP devices 11, 12 are devices for performing communications using SIP and for executing primary device functions (device functions), for example, to control home information appliances. Also, SIP devices 11, 12 can be maintained and managed by maintenance/management device 10.

FIG. 5 is a block diagram of a SIP device according to the embodiment. Referring to FIG. 5, SIP devices 11, 12 are provided with device function unit 31, maintenance/management processing unit 32, and SIP processing unit 33.

Device function unit 31 executes device functions as the SIP device. Device function unit 31 transmits and receives information necessary for executing device functions (hereinafter, called device function information). For example, device function information is transmitted and received between SIP devices.

Maintenance/management processing unit 32 executes maintenance/management control instructed by maintenance/management device 10. Maintenance/management processing unit 32 transmits and receives maintenance/management information necessary for executing the maintenance/management control. Control from maintenance/management device 10 is transmitted to SIP devices 11, 12 as maintenance/management information. Control execution results of maintenance/management processing unit 32 are transmitted to maintenance/management device 10 as maintenance/management information.

SIP processing unit 33 performs the SIP process for the device function information processed by device function unit 31 for and maintenance/management information processed by maintenance/management processing unit 32, and transmits and receives SIP packets to/from maintenance/management device 10.

Firewall 13 is provided with to ensure security of LAN 15 connected with SIP device 11 and restricts communications between LAN 15 and Internet 14 in accordance with specified settings.

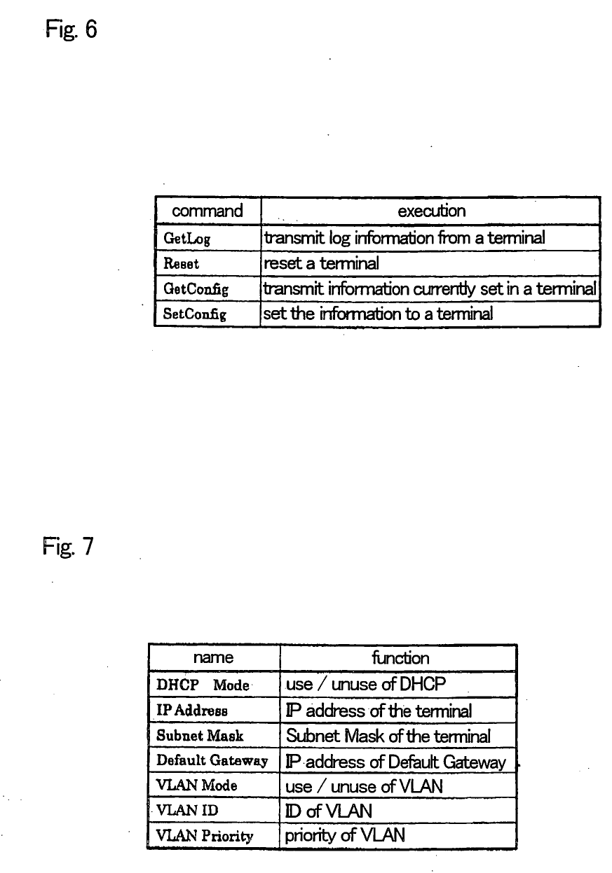

FIG. 6 is a table of an example of maintenance/management control commands. In this embodiment, these maintenance/management control commands are added to SIP. Maintenance/management device 10 is able to inform SIP devices 11, 12 of these commands by SIP. SIP devices 11, 12 are able to analyze these commands and to execute maintenance/management control in accordance with the commands.

Referring to FIG. 6, commands, such as “GetLog”, “Reset”, “GetConfig”, and “SetConfig”, are specified.

GetLog is a command instructing that log information stored in SIP devices (terminals) be transmitted to maintenance/management device. Reset is a command instructing that SIP devices be reset. GetConfig is a command instructing that information currently set in SIP devices be transmitted to the maintenance/management device. SetConfig is a command instructing that the information be set from the maintenance/management device to the SIP devices.

Maintenance/management processing unit 21 in maintenance/management device 10 transmits these commands to SIP devices 11, 12 as maintenance/management information. Maintenance/management processing unit 32 in SIP devices 11, 12 receives these commands and executes them. For example, when the Reset command is received, maintenance/management processing unit 32 resets the SIP device itself. When GetLog command or GetConfig command is received, maintenance/management processing unit 32 transmits an operation status log or information to be set to maintenance/management device 10. Further, when SetConfig command is received, maintenance/management processing unit 32 sets the setting information to the SIP device itself.

FIG. 7 is a table of an example of setting information for the SIP device. Referring to FIG. 7, the setting information includes “DHCP Mode”, “IP Address”, “Subnet Mask”, “Default Gateway”, “VLAN Mode”, “VLAN ID”, and “VLAN Priority”.

Explanation is given of an example of the operation of the maintenance/management system according to this embodiment.

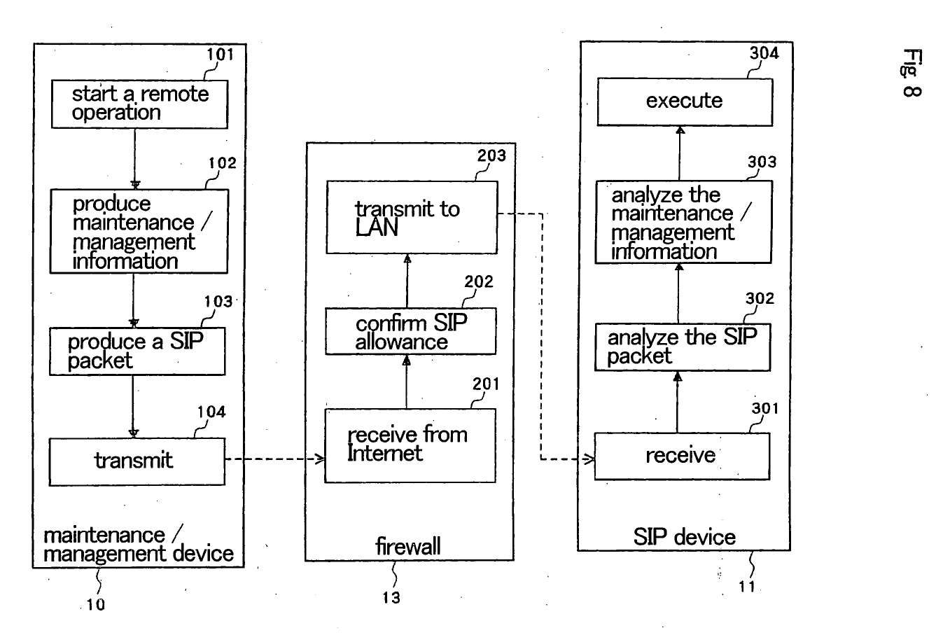

FIG. 8 is a view for explaining the example of the operation of the maintenance/management system. In FIG. 8, maintenance/management control for SIP device 11 connected to internet 14 via firewall 13 is shown as an example.

Referring to FIG. 8, first of all, when the operator starts an input operation, maintenance/management device 10 determines the maintenance/management control that is to be executed in accordance with the input (Step 101). Then, maintenance/management device 10 produces maintenance/management information to be transmitted to SIP device 11 (Step 102). Subsequently, maintenance/management device 10 produces SIP packets including the produced maintenance/management information (Step 103) that has been generated, and transmits the SIP packets to SIP device 11 (Step 104).

The SIP packets that are transmitted from maintenance/management device 10 are received by firewall 13 via Internet 14 (Step 201). Firewall 13 confirms that communication of the SIP packets is allowed (Step 202), and transmits the SIP packets to SIP device 11 via LAN 15 (Step 203).

The SIP packets transmitted from firewall 13 to LAN 15 are received by SIP device 11 (Step 301). Then, SIP device 11 analyzes the SIP packets (Step 302), and extracts maintenance/management information. Further, SIP device 11 analyzes the maintenance/management information (Step 303), and executes the operation instructed by the maintenance/management information.

As described above, according to this embodiment, in SIP device 11, SIP processing unit 33 transmits and receives the device function information and the maintenance/management information in accordance with SIP, and maintenance/management processing unit 32 performs the maintenance/management control in accordance with the maintenance/management information transmitted and received by SIP processing unit 33 using SIP packets. Therefore, it is unnecessary to implement protocols except SIP which is fundamentally necessary for SIP device 11. Also, in the configuration using firewall 13, it is unnecessary for firewall 13 to allow protocols except for SIP, and operations to set information are not required. As a result, remote maintenance/management is possible easily at low cost while retaining a high level of security. In SIP devices connected via Internet 14, namely, a public network, it is possible to prevent damage, such as that caused by a virus, from occurring while retaining a high level of security.

Also, according to this embodiment, the maintenance/management device informs the information communication device of commands for maintenance/management control in accordance with the communication protocol for the device functions, and the information communication device analyzes these commands and executes the maintenance/management control in accordance with the commands. Therefore, only by adding simple commands to SIP, can remote maintenance/management maintaining a high level of security be performed easily.

While preferred embodiment of the present invention has been described using specific terms, such description is for illustrative purpose only, and it is to be understood that changes and variations may be made without departing from the spirit or scope of the following claims.

What is claimed is:

1. A remote maintenance/management system for performing maintenance/management for a device implemented with a communication protocol used to execute a device function from a remote location, said system comprising:
an information communication device for transmitting and receiving maintenance/management information for maintenance/management by the same communication protocol as device function information for the device function and for executing maintenance/management control in accordance with maintenance/management information; and
a maintenance/management device for transmitting and receiving maintenance/management information to/from the information communication device in accordance with the communication protocol and for instructing the information communication device to execute the maintenance/management control.

2. The remote maintenance/management system according to claim 1, wherein the information communication device and the maintenance/management device are connected via a public network.

3. The remote maintenance/management system according to claim 1, wherein the communication protocol is SIP to which commands for maintenance/management control are added.

4. An information communication device implemented with a communication protocol used to execute a device function, comprising:
a communication protocol processing unit for transmitting and receiving maintenance/management information for maintenance/management in accordance with the same communication protocol as device function information for the device function; and
a maintenance/management processing unit for executing maintenance/management control in accordance with maintenance/management information.

5. The information communication device according to claim 4, wherein maintenance/management information is transmitted and received to/from a maintenance/management device connected via a public network in accordance with the communication protocol.

6. The information communication device according to claim 4, wherein the communication protocol is SIP to which commands for maintenance/management control are added.

7. A maintenance/management device for performing maintenance/management for an information communication device implemented with a communication protocol used to execute a device function from a remote location, said device comprising:
a communication protocol processing unit for transmitting and receiving maintenance/management information to/from the information communication device in accordance with the communication protocol; and
a maintenance/management processing unit for instructing the information communication device to execute the maintenance/management control in accordance with the maintenance/management information.

8. The maintenance/management device according to claim 7, wherein the maintenance/management device is connected to the information communication device via a public network.

9. The maintenance/management device according to claim 7, wherein the communication protocol is SIP to which commands for maintenance/management control are added.

10. A remote maintenance/management method for performing maintenance/management for an information communication device implemented with a communication protocol used to execute a device function from a remote location, said method comprising:
a step of transmitting and receiving maintenance/management information between a maintenance/management device and the information communication device in accordance with the communication protocol so that the maintenance/management device instructs the information communication device to execute maintenance/management control; and
a step of executing the maintenance/management control instructed from the maintenance/management device in the information communication device.

11. The remote maintenance/management method according to claim 10, wherein the information communication device and the maintenance/management device are connected via a public network.

12. The remote maintenance/management method according to claim 10, wherein the communication protocol is SIP to which commands for maintenance/management control are added.
